(19) United States
(12) Patent Application Publication
(10) Pub. No.: US 2015/0112838 A1
(43) Pub. Date: Apr. 23, 2015

(54) SMART DEVICE ASSISTED COMMERCE

(71) Applicants: Hong Li, El Dorado Hills, CA (US); Eddie Balthasar, Folsom, CA (US); Rita H Wouhaybi, Portland, OR (US); Taeho Kgil, Foster City, CA (US); Mark Price, Placitas, NM (US); Anand Rajan, Beaverton, OR (US)

(72) Inventors: Hong Li, El Dorado Hills, CA (US); Eddie Balthasar, Folsom, CA (US); Rita H Wouhaybi, Portland, OR (US); Taeho Kgil, Foster City, CA (US); Mark Price, Placitas, NM (US); Anand Rajan, Beaverton, OR (US)

(21) Appl. No.: 13/992,380

(22) PCT Filed: Dec. 19, 2011
(86) PCT No.: PCT/US2012/065863

§ 371 Date: Nov. 19, 2013

(51) Int. Cl. G06Q 30/06

(52) U.S. Cl. CPC G06Q 30/0623
USPC 705/26.61

(57) ABSTRACT

Systems, devices, and methods used to provide real-time product information for retail products and services are generally disclosed herein. One example embodiment includes a referral application operating on a smartphone, configured to correlate data from multiple sources and provide context-aware recommendations and information relevant to a product or service being evaluated by a consumer in the physical shopping environment (such as a retail store). For example, the data may be obtained from a retailer's product information database, a retailer's competitor information database, an advertiser information database, an Internet-hosted service, a social network, or similar internal or external information sources. The real-time product information may be correlated, aggregated, and displayed to the user to either facilitate the retail purchase in the store, or encourage another online or retail purchase. Techniques for providing location-based advertisements and tailored product offerings based on the user's shopping activity are also described herein.

### TECHNICAL FIELD

Embodiments pertain to the use of mobile electronic devices and electronic commerce activities. Some embodiments relate to the use of mobile electronic devices within a retail commerce environment.

### BACKGROUND

When a consumer enters a retail store to shop for a product or service, the consumer will need to make purchase decisions based on static memorized information that he or she acquired before coming to the store. Thus, if the consumer is interested in a new product or service, the information that the consumer can learn about the product or service is generally limited to whatever marketing information the manufacturer or retailer provides, such as via advertisements, product packaging, or limited product displays.

Various Internet sites and software applications exist to provide consumers with information on products and services, including shopping comparison sites and mobile applications (“apps”) that provide reviews, prices, and other useful information relevant to a product or service. These sites and apps, however, are manually and individually accessed by the consumer, and generally do not provide focused information relevant to a consumer's purchase decision of a certain product or service when the consumer is in a retail or other commerce environment.

### BRIEF DESCRIPTION OF THE DRAWINGS

FIG. 1 provides an illustration of an information flow to a smartphone application in a retail commerce environment according to an example embodiment;

FIG. 2 provides an illustration of an architecture for a referral electronic commerce application according to an example embodiment;

FIG. 3 provides an illustration of a smartphone application graphical user interface providing a context-aware display of real-time product information according to an example embodiment;

FIG. 4 provides a flowchart illustrating a method for facilitating a context-aware display of real-time product information according to an example embodiment; and

FIG. 5 illustrates a block diagram of an example machine upon which one or more embodiments can be implemented.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure provides techniques and configurations used for providing real-time information of a product or service to a consumer. This may significantly improve a user's in-store retail shopping experience by automatically providing relevant and timely product information. This may further enable a user to receive more comprehensive and accurate information about a product or service, and assist the user in his or her decision making process involving the product or service.

As used herein, the term “real-time product information” is used to generally refer to information related to a discrete product or grouping of products, including product features, product ratings, product reviews, price comparisons, other suppliers or locations for the product, social network data, news related to the product, and like information which may be useful in the evaluation of a particular product offering. Further, although the following examples are provided with reference to discrete items such as retail goods, it will be apparent that like information and information techniques may be provided using the described embodiments for services and bundling of products and services.

Using the example embodiments, real-time product information may be accessed by a consumer who is browsing a retail store offering goods and services, with the use of a mobile device such as the consumer's smartphone or other portable computing apparatus. Some of the example embodiments described herein allow an interface between the smart device and a retailer's information databases, to provide a consumer with retailer-exclusive or other private product information; whereas other example embodiments obtain information exclusively from publicly available data sources such as Internet web sites and web services.

A variety of techniques and configurations may be used to provide the automatic context-aware execution of data collection, transmission, correlation, and recommendations to a mobile device in a real-time consumer shopping environment. Moreover, a system architecture to implement the presently described techniques may be provided to support any combination of Internet connectivity, near field communications (NFC), correlation information, shopping referral information, and Internet-derived information. An application supported by the system architecture may provide a display of multi-media data in a variety of formats and form factors, delivered to provide a consumer user with an improved in-store commerce experience.

In existing shopping scenarios, a consumer is generally unable to find additional information beyond what is displayed in product packaging, provided in a retail product display, or communicated by a retail sales person. If the user is equipped with an Internet-connected smart device, or the store provides some on-line Internet access, the user may be able to manually query a search engine for more data or perform basic research on the product.

Some existing smartphone apps allow the user to scan a product bar code, such that if the product bar code is located in a public database, the app may display the basic product specifications, product price, product reviews, and allow the user to compare prices of a product across several e-commerce sites using Internet searches. If the e-commerce retailer has a physical presence, the smartphone app might also show the consumer where the nearest store of the retailer is located. In this scenario, however, the smart device is simply used to provide Internet access for the user to manually locate additional information.

With existing smartphone applications, not only does the user need to manually find the information, but the user has to manually process the information, and link the information that he or she obtains from the Internet with the product displayed at the store at the time the user is considering a purchase. Thus, the information that the user can obtain from existing techniques lacks real-time context to the user's activity, and is not correlated to the product display, retail location, or shopping environment of the user.

Likewise, the use of QR codes on retailer displays or product packaging is typically only used to link to a retailer's or manufacturer's website. Although these websites may provide more information than is provided by a physical product display, such websites typically do not provide an unbiased view of the product, or provide the consumer with relevant information obtained from a competing retailer or product manufacturer.

Thus, existing techniques for obtaining product information for consumers result in the collection of static, limited information (often from a single, partial source). Further, existing techniques generally do not provide any in-store information or context for the information, and do not result in information correlation or intelligent recommendations.

The presently described techniques are designed to improve a consumer's in-store shopping experience by offering automated provisioning of real-time product information (such as product ratings, price comparisons, competitors, other sellers/locations, social network information and the like) using a smart device. In one embodiment, this is performed through the automatic and context-aware performance of data collection, transmission, correlation, and recommendations using a referral application operating on a mobile device.

In an example embodiment, a referral software application executing on a consumer's smartphone may be configured to interface with a plurality of information sources. For example, the referral application may request and receive information from a variety of networked and non-networked sources, including an electronic product information data source, and various relevant Internet sites. The referral application may coordinate this information in connection with location information or physical-related information, such as a product barcode or radio frequency identifier (RFID) tag, to correlate use of the referral application to offerings in a retail commerce environment.

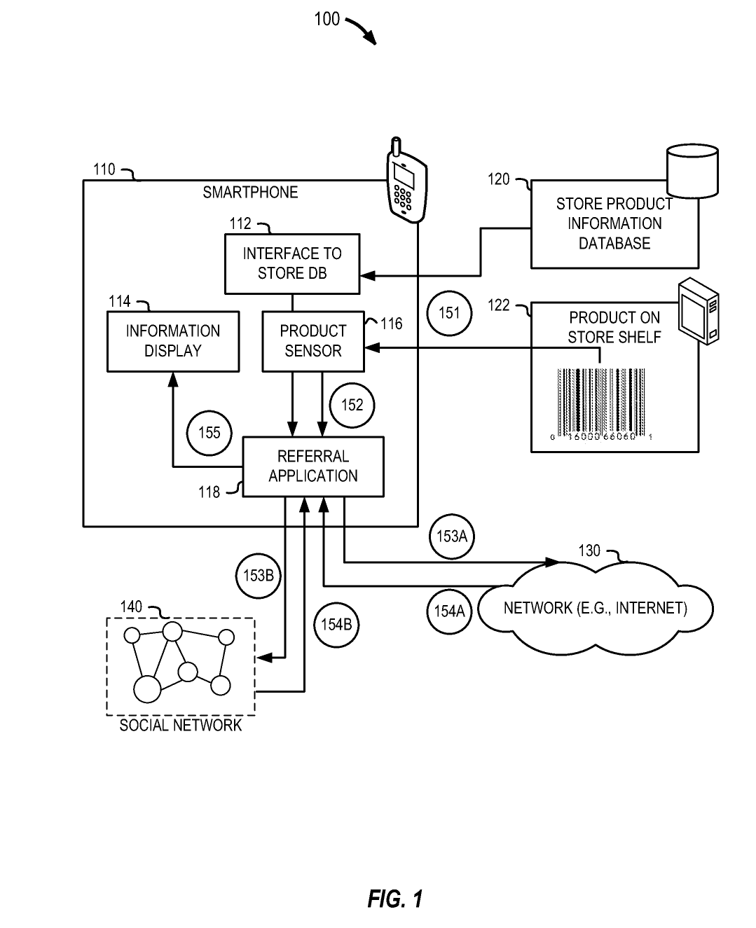

FIG. 1 provides an illustration of an infrastructure and information flow 100 using a referral application of a smartphone in a retail commerce environment according to an example embodiment. As shown, a smartphone 110, operable by a consumer, provides a number of components for coordinated operation with a physical product information display, including a store product information database interface 112, an information display 114, a product sensor 116, and a referral application 118.

As examples, the store product information database interface 112 used to connect to a store product information database 120 may utilize internet connection and internet connectivity services within the smartphone 110, such as a Wi-Fi or 3G/4G wireless network. Product information on a particular product offering or a series of product offerings may be downloaded on demand (for example, when a particular product on the store shelf is being viewed), or in advance (for example, when a consumer enters a particular department of a retail store).

The product sensor 116 may include any or multiple of an embedded camera, a laser scanner, a near field communication device, other device of the smartphone 110 used to capture input from a product identifier, and accompanying software or hardware for processing. In one embodiment, the product identifier is obtained from a barcode (for example, in a UPC standard format or in QR format) presented by a product on store shelf 122, which is captured through use of a camera and processed for identification data. In an alternate embodiment, a product identifier may be obtained through optical character recognition of identified text, or image recognition of an identified logo on the product display. In an alternate embodiment, a product identifier may be obtained through near field communication (e.g., wireless communication) with an individual product, product display, or other relevant object having a communication device.

The interface to the store product information database 112 may be provided in connection with product sensor 116. For example, this may be provided by using a read barcode identifier to look up a product in the store product information database 120. In other embodiments, the interface to the store product information database 112 may be connected to referral application 118 directly.

The referral application 118 operates to collect and determine relevant information to display for the user, based on the commerce environment and user activity in the commerce environment such as the user evaluating a specific product. The referral application 118 is operably connected to the information display 114, such as may be provided by a display of a smartphone to output relevant real-time product information to the user. The referral application 118 may also interface with other human input devices or interfaces to collect user input, such as may be provided by a touch screen display (for example, embodied by the information display 114), a keyboard, voice recognition device, image recognition device, and like input and input processing components.

As previously suggested, the referral application 118 is configured to obtain input from the store product information database interface 112 and the product sensor 116. The referral application 118 may be operated by the user to obtain real-time product information related to a specific product (such as the product 122 provided in a retail display). The referral application 118 may also automatically or manually obtain information related to the specific product, based on the commerce environment (for example, obtained through near field communications between store displays and the smartphone 110). Related product information may be provided through a connection to a network 130, which may comprise a product information network, a product information service, or an internet connection to publicly available websites.

The referral application 118 may also automatically or manually obtain information related to the specific product through dynamic information sources such as a social network 140. The social network 140 may provide information related to a particular product or service based on social connections and preferences (for example, a number of friends who “like” a particular product, have reviewed a particular product, or have indicated use of or have otherwise discussed a particular product).

Information may be requested from the store product information database 120, network 130, and social network 140 based on any number of triggers, such as detection of a RFID tag provided by the user's proximity to the product, or the user manually requesting information by focusing the referral application on a barcode of a particular product. Information may also be targeted to the user at particular times, for example, in connection with promotional sales or events intended to drive sales to a particular product. Relevant demographic and advertising information known by the commerce environment operator (such as loyalty or frequent shopper information) may be used to further customize the type of real-time product information displayed, as well as the use of any special offers to accompany the real-time product information.

A series of operations 151, 152, 153, 154, and 155 depicted in FIG. 1 provide an illustration of information flow occurring between the referral application 118 and various input and output locations. The following sequence is provided for an illustration of an example use of the referral application 118 in a retail environment, but is not intended to limit the applicability or use of the referral application. Thus, the information flow depicted in these operations provides only a small number of examples and applications of information flow.

As shown, information is obtained in data flow 151 from product sources related to the retail product offering, for example, from store product information database 120 or from the product on the store shelf 122. For example, barcode information from the product on the store shelf may be provided to the product sensor 116 to first identify the product, followed by retrieval of the store product information using an interface to the store product information database 112.

In data flow 152, the data collecting interface on the referral application 118 receives the data from either or both of the product sensor 116 and the interface to the store product information database 112. The data may include a simple bar code identifier or product stock keeping unit (SKU) identifer, a picture of the barcode or the product, product pricing information, product details, retailer-specific information on the product and related offers, and the like.

In data flow 153A, the referral application 118 translates the data to specific keywords or metadata that may be used to obtain additional information from specific service providers via network 130. Service providers may include search engines, other retailer interfaces, product review and ratings sites, other internet information sites, and the like. The service providers may be identified or selected by the user, the operator of the retail environment, advertisers, or a provider of the referral application.

In data flow 153B, the referral application may use similar keywords or metadata to obtain additional information from social network 140 and similar social media services (for example, whether the consumer's social network connections are recognized as users of the product, or have provided any information relevant to the product on a social network or social media site). In data flow 154A, the internet information providers from the network 130 send back relevant information to the referral application 118; and in data flow 154B, relevant information from the social network 140 is provided back to the referral application 118.

The referral application 118 on the smartphone 110 then aggregates the data received from each of the aforementioned sources, and correlates such information to a useful format (e.g., in the form of decision recommendations or product information details) provided to an output of the smartphone 110. This information may be provided, for example, through data flow 155 to the information display 114 in the form of a graphical user interface.

In alternate embodiments, the store product information database 120 and the interface to store product information database 112 may not be provided in all environments. For example, if the user is browsing products in a retail store which does not provide an interface to its data, then the user may use a number of other features of the referral application 118 such as the product sensor 116, connection to network 130, connection to social network 140, and the like, to collect the real-time product information. Further, in other alternate embodiments, the use of information from social network 140 or network 130 may be optional, such that the retailer or a set of retailers exclusively provide the real-time product information.

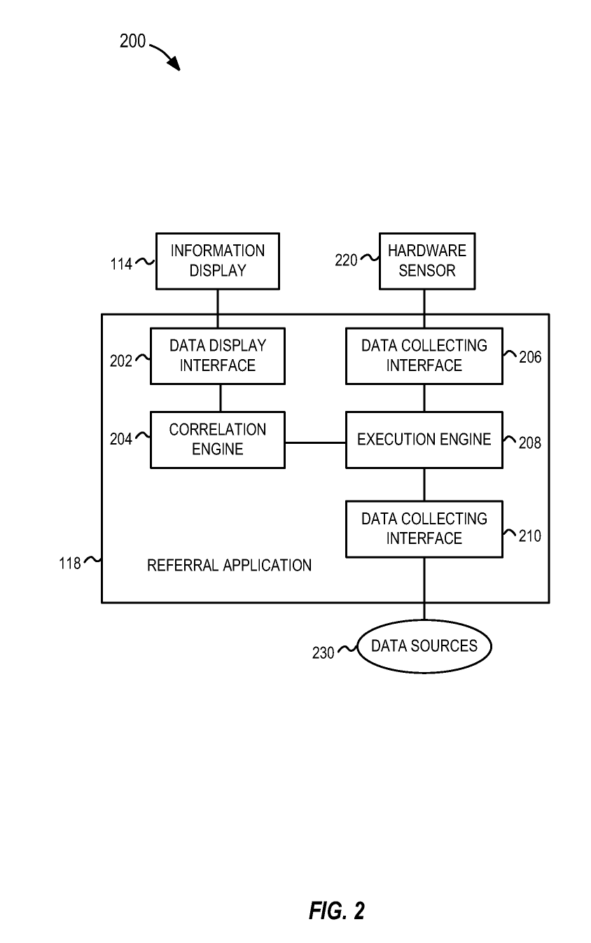

FIG. 2 illustrates a detailed architecture 200 used for the operation of a referral application 118 (such as previously described with reference to FIG. 1) according to an example embodiment. Architecture 200 may be used in conjunction with an embodiment operating on a smartphone 110, although referral application 118 may be operated in part or in whole by a remote server.

As illustrated, referral application 118 provides a number of interfaces and engines used to perform collection, aggregation, and display of relevant real-time product information. These include, a data display interface 202 used to provide electronic data output (e.g., in the form of a graphical user interface) to an information display 114 (such as a touch screen of a mobile device); a correlation engine 204 used to correlate a product display with information obtained from real-world and electronic sources; a data collecting interface 206 used to collect real-world product information from a hardware sensor 220 (such as a product barcode derived from a picture taken with a camera); a data collecting interface 210 used to collect virtual product information from various electronic data sources 230 (such as internet sites and retailer product information services); and an execution engine 208 used to aggregate information from data collecting interfaces 206, 210 into a product information data stream for use with the correlation engine 204.

Although FIGS. 1 and 2 provide illustrative examples of a referral application operating on a consumer's smartphone, it will also be apparent that other hardware devices may be used to execute and operate the referral application in a retail setting. For example, a network-connected portable tablet computer may be used to execute software and perform similar operations. Likewise, a dedicated portable hardware device providing an input and output for use in a comparison shopping setting may execute the referral application. In alternate embodiments, a fixed-location device or system (for example, a stationary kiosk located in a retail environment) may be used to interact with users and provide many of the referral application features described herein.

In alternate embodiments, processing logic for the referral application may be operated remotely, with data provided to a server or cloud-based service for processing, and relayed to a client device for display. For example, data operations 151, 152, 153, and 154 depicted in FIG. 1 may be modified to process data at a server or other remote operating environment. The remote server in turn may perform additional data collection and processing from local or remote networks, and use operation 155 to provide a display from the remote server to a thin client.

To support the previously described configuration and retail shopping applications, communication standards may need to be adapted for use with the referral application. For example, there may be a need for some standard protocols between the manufacturers, vendors, and information service providers (e.g., a standard barcode format, a standard RFID identifier, a standard data query format, and the like). Additionally, if multimedia data such as a picture or a video of the product is being collected, the information service provider(s) may need to be able to support multi-media based searching capabilities based on the particular data format.

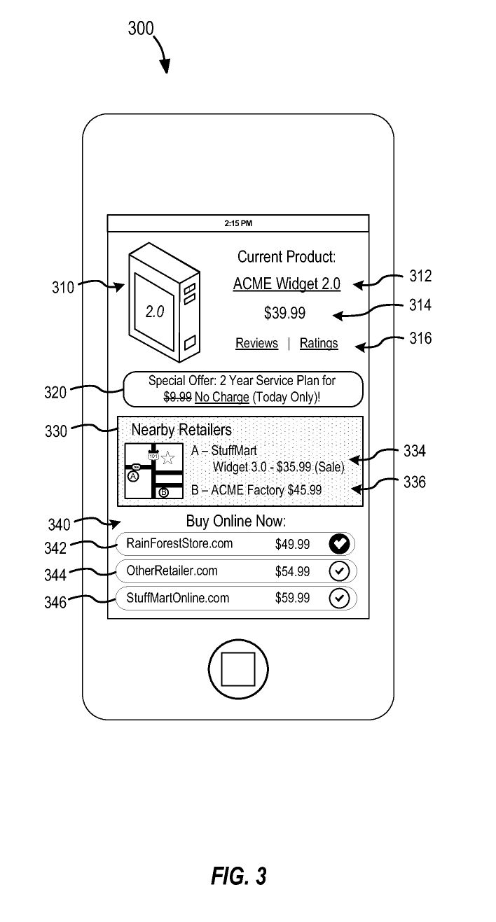

FIG. 3 provides an illustration of a smartphone application graphical user interface 300 providing a context-aware display of real-time product information according to an example embodiment. The illustration of the particular graphical user interface 300 and the content included therein is provided as one non-limiting example of a display, and so it will be appreciated that numerous other configurations and designs may be provided for such a graphical user interface.

An example use case for the graphical user interface 300 may include a consumer browsing a retail store (e.g., a “big-box” store) that offers a series of product displays and product offerings. As shown in connection with graphical user interface 300, a series of product information sections are displayed to correlate with the particular product that the consumer is viewing in the real-life retail environment.

The product information sections of graphical user interface 300 include a product depiction 310 (such as a photo or illustration of the product), accompanying detailed product information link 312, a price display 314, and product reviews and ratings links 316. The user may interact with the graphical user interface 300 to select these links and learn more information on the product. Alternately, content from the detailed information, reviews, or ratings sections might be automatically displayed without user prompting.

The information sections of graphical user interface 300 may also include a special offers display 320 which may be used by the retailer to induce purchase of the product or some other specific consumer behavior. For example, a special offer such as including a service plan with the purchase of the item may be provided as an exclusive offer to users of the smartphone application.

The information sections of graphical user interface 300 may also include a nearby products listing 330, providing prices and listings of the same or comparable products at the same or other retailer nearby. In the case of listing products from the same retailer, the nearby products listing 330 may be linked to an in-store map which provides details on similar or related products (used, for example, to upsell the consumer to another product, to redirect the consumer to an alternative product if the particular product is out of stock, or to suggest another product that may be more aligned with the consumer's needs or budget). In the case of listing products from another retailer, the nearby products listing 330 may be linked to a geographical map to provide directions to visit the other retail location, accompanied by relevant product details (used, for example, to direct the consumer to a competing brand, a better product, or lower price offered by the other retailer). For example, in the illustrated nearby products listing 330, a competing retailer listing 334 shows that a newer version of the product is on sale and available at a competing retailer; while competing retailer listing 336 shows a price for the same product (which is higher) at another competing retailer.

The information sections of graphical user interface 300 may also include an online products listing 340, providing prices and listings of the same or comparable products at the same or other retailer's online stores. The online products listing 340 may include buttons or other interactions used to visit a website or launch a purchasing interface, such as illustrated with buttons 342, 344, 346 to purchase the product being viewed in real-life from various online retailers. In a further embodiment not shown, the online products listing 340 may include the ability to electronically purchase the product from the retailer being visited, for example, to initiate a purchase for customer pickup at another location in the store, or to initiate a purchase for shipping of the product to the consumer's home address if the product is not in stock at the current location.

In some embodiments, the graphical user interface 300 may be tied or distributed in conjunction with a retailer's branded smartphone application. In other embodiments, the graphical user interface 300 is provided as a standalone application, and not associated with any specific retailer, although the retailer may be directly providing content and information to the application. Thus, the content provided in the graphical user interface 300 may not only include offers and information generated and controlled by a single retailer, but may also include offers and information provided by a plurality of competing retailers. For example, the referral application may allow a user to express interest in a product, and provide competing retailers with the opportunity to respond to that interest (for example, with customized advertisements or promotions delivered through the referral application).

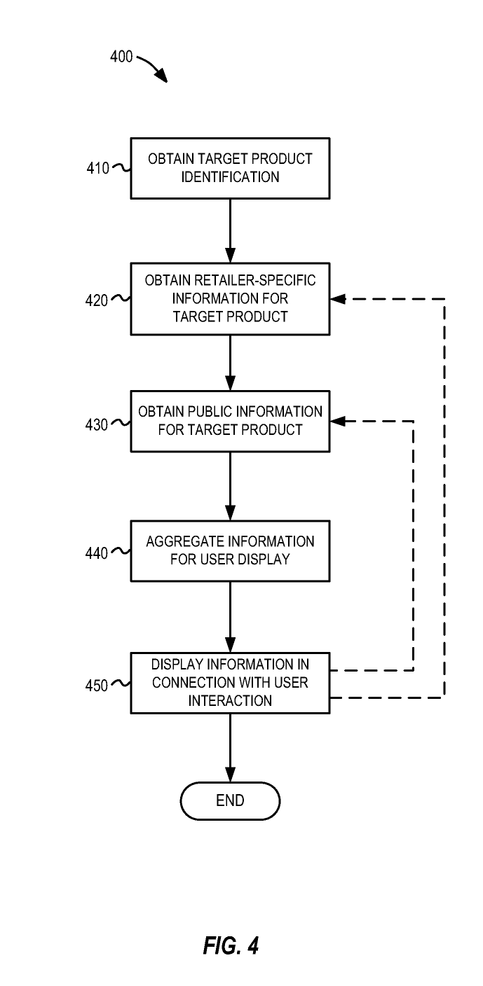

FIG. 4 provides an overview of a method 400 for facilitating a context-aware display of real-time product information according to an example embodiment. The following operations are not required to be performed in a consecutive order or sequence, although the illustrated order depicts use of the method in a common consumer shopping experience.

In operation 410, product identification for the target product is obtained. This may be obtained, for example, by a consumer taking a picture of a product barcode or product display. Alternatively, the target product may be detected through the use of NFC, such as an RFID identifier provided by proximity to the target product. Various internal and external databases (for example, a public barcode or retailer SKU database) may also be used to assist the target product identification.

In operation 420, retailer-specific information for the target product is obtained, through use of the target product identification. Information may be obtained, for example, from one or more data sources, such as an internal products database configured to interface with a referral application. Information may also be obtained from a publicly available web service containing retailer-specific information.

In operation 430, public information for the target product is also obtained through use of the target product identification (and in some cases, the additional retailer-specific information). Information may be obtained, for example, from one or more data sources, such as publicly available websites, web services, and service providers. These publicly available websites may require authentication or user-specific information to fully access the data. Additional information such as social networking information or social media information may also be collected in this operation.

In operation 440, the various information and information links collected from operations 410, 420, and 430 are aggregated for user display. For example, this may be aggregated for use in connection with a smartphone application. This may also be aggregated for use in connection with hosting from a website accessible by a general internet-accessible interface.

Finally, in operation 450, the aggregated information from operation 440 is displayed to a user, and is adapted and updated in connection with user interaction with the displayed user interface. For example, a smartphone application may provide various screens with additional information as accessed by the user. Likewise, a server-hosted website may provide various webpages with additional information as accessed by the user. Additional information may be optionally retrieved through additional execution of either or both of operation 420 and operation 430, for example, as a consumer requests additional information not aggregated for display in the graphical user interface.

In one embodiment, real-time product information for display to a user may be determined by correlating retrieved product information to the physical display of the product and user activity in the commerce environment. Such user activity may include, but is not limited to: a user evaluating a particular product type for a period of time, such as spending a certain period of time in a retail store department; a user evaluating a particular product for a certain period of time (e.g., standing next to a product display for more than 2 minutes); a user evaluating a particular brand or type of product; and like user actions in the commerce environment.

User activity in the commerce environment may also be determined in connection with a user's direct activity with a smartphone application that occurs inside or outside of the commerce environment. For example, user activity may be detected from: a user looking for a particular product on an online e-commerce website; user search activity; or user input allowing a user to indicate that he or she is interested in a product or a family of products.

Further, the user's activity with a smartphone application that is factored may include a user's recent history of activities assisted by their mobile device, including on-line or other shopping activities, that are related to the current product he or she is looking at. For example, if the user scans a digital camera in a store, the smartphone application may check the user's recent purchasing or inquiries related to cameras and display relevant information such as “the X brand lens you purchased on dd/mm/yy will not work with this camera model”, or “the X lens you just bought will work with the Y model camera also available at this store.”

The following real-life, non-limiting examples provide a series of additional use-case scenarios for the consumer access of real-time product information in a retail setting. The following examples are intended to be used in conjunction with the embodiments described herein, such as the referral application 118 depicted in FIGS. 1 and 2, and the graphical user interface 300 depicted in FIG. 3. It will be apparent, however, that various modifications to the referral application 118 and graphical user interface 300 may be implemented in the following scenarios.

For example, not only can the referral application be used by a consumer to obtain information on demand (such as when the consumer launches the referral application at a product kiosk to learn more about a specific product or service), but the referral application may also provide a framework for stores to reach the smartphone and the consumer. Additional products and offers may be targeted at specific consumers based on their real-time activity in the retail environment with the referral application. Thus, rather than simply providing a list of prices from a list of retailers, a full stream of information relevant to the product (and the user) is capable of being provided.

As another example, the referral application may be used to enhance the consumer's physical retail shopping experience. For example, an option may be presented for the consumer to request assistance, or relevant store assistance may be automatically delivered to the consumer. For example, as a consumer scans a specific Blu-Ray player to learn more information, the retailer can recognize that a home theater expert rather than a computer expert should be directed to the location of the consumer.

As another example, relevant information may be provided or collected through the referral application to facilitate user-driven reviews, ratings, and comments about a particular retail location. Based on the user's detected location, for example, the referral application can locate reviews of the retailer, and various services that the retailer may offer. This may be useful when the consumer is buying from a new small business, and the consumer is not aware of the business' return policy, or other factors that might be of interest.

As another example, a consumer may use the referral application when entering a retail environment to learn more about the store and promotions at the store. For example, when a consumer enters the store, the referral application could be used to display “hot” items, such as popular, fast-selling, or other products of interest at this particular store or retailer. The referral application may also display product information and listings based on recent reviews, product ratings, and other consumer interest in particular products or product displays.

As another example, the referral application may be used to provide price and offer matching in conjunction with various products or services. For example, a retailer may dynamically match prices, bundled offers, or provide additional incentives to purchase the physical product, based on real-time offerings discovered from other retailers within the referral application. This type of offer delivery may also be used by product distributors and manufacturers, for example, to match or newly offer rebates and other incentives in real-time to induce purchase of a particular product.

As another example, the referral application may be used to access ratings and reviews across a limited number of sites (for example, for the retailer's vetted reviews on its website), or for a large number of web sites (for example, aggregated from Internet retailers, product review sites, consumer reports, news media sites, professional review sites, and the like). The referral application therefore may be customized by the retailer to provide a tailored and filtered experience when the consumer is browsing in the retail environment; whereas when visiting other retailers which do not support a custom referral application, general publicly available information (untailored and unfiltered) might be provided to the consumer.

As another example, the referral application may be used to present prices and ratings to a consumer in various graphical formats, for example, as a heatmap, or in a location-based comparison format. This heatmap may provide an intuitive comparison between multiple retailers, or between multiple products offered by a single retailer. This may help the user decide whether to buy the product now from the retail store, shop at another retailer, order the product online, or delay the purchase. This type of a comparison may also help the consumer identify whether it is worth waiting for a product to be shipped from an online source, or have the immediate satisfaction of instantly purchasing the product.

As another example, the referral application may be used to compare a product that was scanned by the consumer to other products in the same category in order to identify the lowest price or “best” quality options within the retail environment. This also has the potential of informing the consumer whether the retail store has a similar item on sale that might not be located near the product being viewed (thus, providing a strategy to make the consumer consider purchase a more expensive option, or secure a sale of another promoted product).

As another example, the referral application may be used to identify matching products in product categories for a consumer. For example, the consumer may see an ACME brand television, without knowing whether it is better than other brands. The referral application may be used to perform a comparison between products within brands or among brands, and provide more intelligent product selection for users.

As another example, retail stores may provide additional supply or inventory information to consumers, to allow a consumer to check if the item is available in inventory. This may include having the retailer integrate specific local applications and sensor capabilities with the product, and provide NFC capability between the smart device and the product box or shelf-location. When trying to make a sale, stores can redirect the consumer to another location in the store, to an online version of the product, to another store location, and the like. Use of the referral application may be provided in conjunction with sensors measuring the inventory and in store value, thus providing real-time information on product availability. Retailers may also measure product interest in a particular product (and adjust store inventory, for example) based on usage of the referral application at a particular product display, and coordinate activity with inventory management.

As another example, consumers may use the referral application to access or leave comments about a particular product offering. For example, a consumer (or competitor) may provide an indication that the product is cheaper at a particular store, or even provide a link to a nearby store which has a better price on this item. The referral application could facilitate competition from another retailer, even directly at the point of sale as the consumer is browsing another retailer's location. Thus, another retailer (e.g., whether an electronic retailer or another physical-presence retailer) could compete electronically while a consumer is shopping in another store. Relevant advertisements, offers, and the like can be delivered to the consumer at appropriate times—namely, when the consumer is directly evaluating a product display.

Use of the referral application may significantly improve the user's in-store shopping experience by providing information (real-time, more accurate, comprehensive, and recommendation-based) for a product, which is otherwise unavailable for a user while shopping in-store. Further, the smart device may function as a point of sale, while also providing information and recommendations that enable consumers to make better decisions.

Although the configurations described herein provide examples of shopping in a physical retail environment, like techniques are equally applicable to provide product and service information to consumers in a non-retail environment, such as obtaining product reviews, help, or replacement information for an already-purchased product. Further, the terms “retail environment” and “commerce environment” as used herein are not limited to a traditional brick-and-mortar store featuring a plurality of product displays, but may also include any number of commercial activity environments, including warehouse clubs, wholesale shops, consignment stores, swap meets, auctions, private used good sales, and similar settings where the sale or transfer of goods and services takes place.

Further, the terms real-time product information and product information as used herein are not necessarily limited to information provided in connection with a product purchase. Product information as provided and output to a user may include any form of text, audio, video, or multimedia content. Thus, the collection and use of data relevant to a product or service in a variety of settings may be included within the scope of the presently described embodiments.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the base station or the UE may include one or more processors and may be configured with instructions stored on a computer-readable storage device.

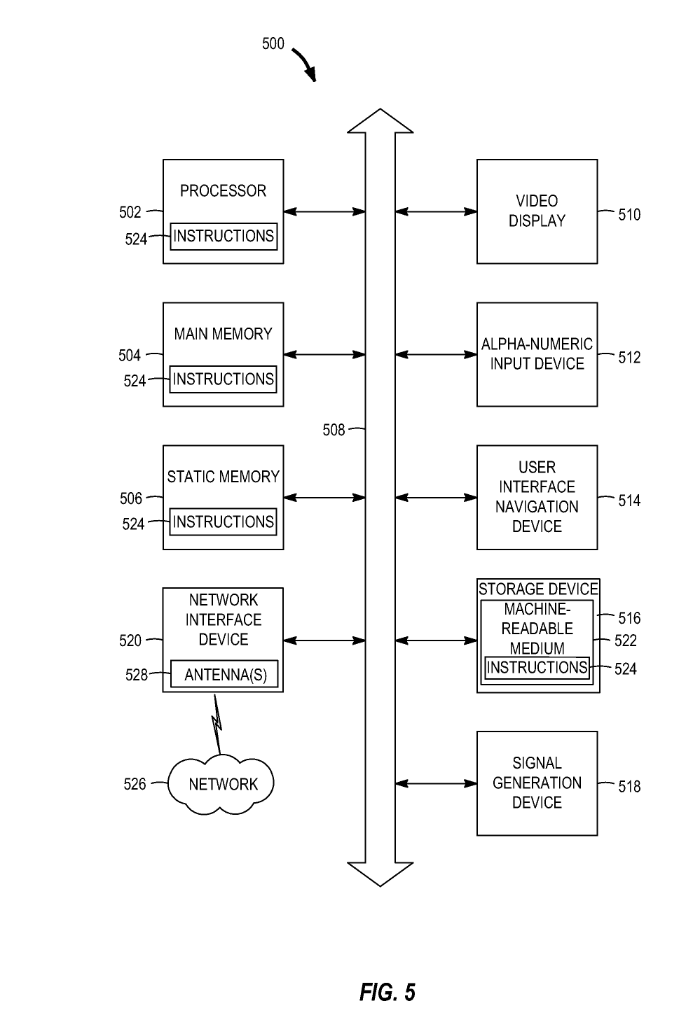

FIG. 5 is a block diagram illustrating an example machine upon which any one or more of the methodologies herein discussed can be run. In alternative embodiments, the machine operates as a standalone device or can be connected (e.g., networked) to other machines. In a networked deployment, the machine can operate in the capacity of either a server or a client machine in server-client network environments, or it can act as a peer machine in peer-to-peer (or distributed) network environments. The machine can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes a processor 502 (e.g., a central processing unit (CPU), a graphics processing unit (GPU) or both), a main memory 504 and a static memory 506, which communicate with each other via a bus 508. The computer system 500 can further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are a touch screen display. The computer system 500 can additionally include a storage device 516 (e.g., a drive unit), a signal generation device 518 (e.g., a speaker), a network interface device 520 (which may include or operably communicate with one or more antennas 528, transceivers, or other wireless communications hardware), and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 can also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” can include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 524 can further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples can stand on its own, or can be combined in any permutation or combination with any one or more of the other examples provided below or throughout the present disclosure.

Example 1 includes a mobile wireless device, comprising: at least one processor; and at least one memory device providing a plurality of instructions that, when executed by the processor, cause the processor to perform operations that: identify a product using a product identifier, the product having a physical display in a commerce environment; retrieve product information using the product identifier from at least one product information data source; determine real-time product information by correlating the product information to the physical display of the product and user activity in the commerce environment; and display the real-time product information in a user interface provided by the mobile wireless device.

In Example 2, the subject matter of Example 1 can optionally include a camera to capture an image of the physical display; wherein the instructions to retrieve product information include instructions to obtain the product identifier by processing the image, the image representing one or more of: a barcode provided for the product in the physical display, a graphical identifier provided for the product in the physical display, or a textual identifier provided for the product in the physical display.

In Example 3, the subject matter of one or any combination of Examples 1-2 can optionally include a camera to capture an image of the physical display; wherein the instructions to retrieve product information include instructions to obtain the product identifier by processing the image, the image representing one or more of: a barcode provided for the product in the physical display, a graphical identifier provided for the product in the physical display, or a textual identifier provided for the product in the physical display.

In Example 4, the subject matter of one or any combination of Examples 1-3 can optionally include a touchscreen; wherein the user interface is a graphical user interface provided to a user through an electronic display on the touchscreen, wherein instructions for the graphical user interface are executed in the mobile wireless device in connection with the memory device and the processor.

In Example 5, the subject matter of one or any combination of Examples 1-4 can optionally include at least one of the product information data sources that is provided by an operator of the commerce environment, and at least one of the product information data sources that is provided by a searchable Internet service.

In Example 6, the subject matter of one or any combination of Examples 1-5 can optionally include the instructions to display the real-time product information that include instructions to display one or more recommendations or reviews related to the real-time product information.

In Example 7, the subject matter of one or any combination of Examples 1-6 can optionally include instructions to determine the real-time product information that include instructions to determine the real-time product information based on physical or temporal characteristics of the product display or commerce environment, including one or more of: geo-location, time, or pricing.

Example 8 can include, or can optionally be combined with the subject matter of one or any combination of Examples 1-7 to include, a method performed by a computing device, comprising: accessing identification of a product located in a physical display in a commerce environment; requesting, from one or more data sources, product information relevant to the product using the identification of the product; processing the product information relevant to the product to determine real-time product information based on characteristics of the physical display and the commerce environment; and providing, for electronic display, the real-time product information relevant to the product, including customizing the electronic display of the real-time product information based on user activity in the commerce environment.

In Example 9, the subject matter of Example 8 can optionally include receiving the product information from multiple of the data sources, the multiple data sources accessible via a network external to the commerce environment; and aggregating the product information from the multiple data sources to determine the product information relevant to the product.

In Example 10, the subject matter of one or any combination of Examples 8-9 can optionally include performing the method at least in part by a mobile wireless device, the mobile wireless device operable by a user, and the method further comprising: receiving the product information in response to requesting the product information from the one or more data sources; and displaying the electronic display using a screen of the mobile wireless device, the mobile wireless device being operable by the user proximate to the physical display of the product.

In Example 11, the subject matter of one or any combination of Examples 8-10 can optionally include performing the method at least in part by a service remote to a mobile wireless device, the mobile wireless device operable by a user, and the method further comprising: transmitting the real-time product information to the mobile wireless device for display on the mobile wireless device.

In Example 12, the subject matter of one or any combination of Examples 8-11 can optionally include one or more data sources including a product information database provided by an operator of the commerce environment or an entity associated with the operator of the commerce environment.

In Example 13, the subject matter of one or any combination of Examples 8-12 can optionally include one or more data sources including one or more searchable websites.

In Example 14, the subject matter of one or any combination of Examples 8-13 can optionally include one or more data sources including one or more social networks associated with a user or one or more social media sites associated with a user.

In Example 15, the subject matter of one or any combination of Examples 8-14 can optionally include identifying the product provided by the physical display, including capturing an identifier displayed for the product and recognizing the identifier, the identifier provided by one or more of: a barcode, graphical data, or textual data.

In Example 16, the subject matter of one or any combination of Examples 8-15 can optionally include providing, for the electronic display, one or more recommendations or reviews relevant to the product based on the real-time product information.

Example 17 can include, or can optionally be combined with the subject matter of one or any combination of Examples 1-16 to include a computer-readable storage medium having computer-readable instructions, which when executed by the computer, cause the computer to: obtain identification of a product, the product provided with a physical display at a commerce environment; obtain product information relevant to the product from one or more data sources, the product information obtained using the identification of the product; determine real-time product information from the product information using characteristics of the physical display and the commerce environment; and display, in a user interface operable in the commerce environment, the real-time product information.

In Example 18, the subject matter of Example 17 can optionally include computer-readable instructions that further cause the computer to: process input received in the user interface, including obtaining additional product information from the one or more data sources responsive to input received in the user interface.

In Example 19, the subject matter of one or any combination of Examples 17-18 can optionally include computer-readable instructions that further cause the computer to: display, in the user interface, related product information obtained from the one or more data sources for one or more products related to the product.

In Example 20, the subject matter of one or any combination of Examples 17-19 can optionally include one or more data sources that include a product information database provided by an operator of the commerce environment or an entity associated with the operator of the commerce environment.

In Example 21, the subject matter of one or any combination of Examples 17-20 can optionally include one or more data sources that include one or more searchable websites.

In Example 22, the subject matter of one or any combination of Examples 17-21 can optionally include one or more data sources that include one or more social networks associated with a user or one or more social media sites associated with a user.

Example 23 can include, or can optionally be combined with the subject matter of one or any combination of Examples 1-22 to include a system, comprising: a product information database providing information for a plurality of products; and a mobile wireless device connected to the product information database via a wireless network, and providing a referral application which when executed by the mobile wireless device performs the acts of: obtaining an identification of a product provided in a physical display in a commerce environment; obtaining product information relevant to the product from the product information database using the identification; determining real-time product information based on the product information relevant to the product and the physical display of the product in the commerce environment; and displaying, in a user interface on the mobile wireless device, the real-time product information.

In Example 24, the subject matter of Example 23 can optionally include the referral application that when executed by the mobile wireless device further performs the act of: aggregating the product information relevant to the product obtained from the product information database with product information obtained from one or more additional data sources.

In Example 25, the subject matter of one or any combination of Examples 23-24 can optionally include the mobile wireless device that includes a touchscreen, and wherein the user interface is provided through electronic display on the touchscreen.

In Example 26, the subject matter of one or any combination of Examples 23-25 can optionally include the referral application that when executed by the mobile wireless device further performs the acts of: providing, for display in the user interface on the mobile wireless device, related additional product information including information for one or more additional products related to the product.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A mobile wireless device, comprising:
at least one processor; and
at least one memory device providing a plurality of instructions that, when executed by the processor, cause the processor to perform operations that:
identify a product using a product identifier, the product having a physical display in a commerce environment;
retrieve product information using the product identifier from at least one product information data source;
determine real-time product information by correlating the product information to the physical display of the product and user activity in the commerce environment; and
display the real-time product information in a user interface provided by the mobile wireless device.

2. The mobile wireless device of claim 1, further comprising:
a camera to capture an image of the physical display;
wherein the instructions to retrieve product information include instructions to obtain the product identifier by processing the image, the image representing one or more of: a barcode provided for the product in the physical display, a graphical identifier provided for the product in the physical display, or a textual identifier provided for the product in the physical display.

3. The mobile wireless device of claim 1, further comprising:
a radio-frequency identification (RFID) detection unit to detect an RFID identifier provided for the product in the physical display;
wherein the instructions to retrieve product information include instructions to obtain the product identifier by processing the RFID identifier.

4. The mobile wireless device of claim 1, further comprising:
a touchscreen;
wherein the user interface is a graphical user interface provided to a user through an electronic display on the touchscreen, wherein instructions for the graphical user interface are executed in the mobile wireless device in connection with the memory device and the processor.

5. The mobile wireless device of claim 1, wherein at least one of the product information data sources is provided by an operator of the commerce environment, and wherein at least one of the product information data sources is provided by a searchable Internet service.

6. The mobile wireless device of claim 1, wherein the instructions to display the real-time product information include instructions to display one or more recommendations or reviews related to the real-time product information.

7. The mobile wireless device of claim 1, wherein the instructions to determine the real-time product information include instructions to determine the real-time product information based on physical or temporal characteristics of the product display or commerce environment, including one or more of: geo-location, time, or pricing.

8. A method performed by a computing device, comprising:
accessing identification of a product located in a physical display in a commerce environment;
requesting, from one or more data sources, product information relevant to the product using the identification of the product;
processing the product information relevant to the product to determine real-time product information based on characteristics of the physical display and the commerce environment; and
providing, for electronic display, the real-time product information relevant to the product, including customizing the electronic display of the real-time product information based on user activity in the commerce environment.

9. The method of claim 8, further comprising:
receiving the product information from multiple of the data sources, the multiple data sources accessible via a network external to the commerce environment; and
aggregating the product information from the multiple data sources to determine the product information relevant to the product.

10. The method of claim 8, the method performed at least in part by a mobile wireless device, the mobile wireless device operable by a user, and the method further comprising:
receiving the product information in response to requesting the product information from the one or more data sources; and
displaying the electronic display using a screen of the mobile wireless device, the mobile wireless device being operable by the user proximate to the physical display of the product.

11. The method of claim 8, the method performed at least in part by a service remote to a mobile wireless device, the mobile wireless device operable by a user, and the method further comprising:
transmitting the real-time product information to the mobile wireless device for display on the mobile wireless device.

12. The method of claim 8, wherein the one or more data sources include a product information database provided by an operator of the commerce environment or an entity associated with the operator of the commerce environment.

13. The method of claim 8, wherein the one or more data sources include one or more searchable websites.

14. The method of claim 8, wherein the one or more data sources include one or more social networks associated with a user or one or more social media sites associated with a user.

15. The method of claim 8, further comprising:
identifying the product provided by the physical display, including capturing an identifier displayed for the product and recognizing the identifier, the identifier provided by one or more of: a barcode, graphical data, or textual data.

16. The method of claim 8, further comprising:
providing, for the electronic display, one or more recommendations or reviews relevant to the product based on the real-time product information.

17. A computer-readable storage medium having computer-readable instructions, which when executed by the computer, cause the computer to:
obtain identification of a product, the product provided with a physical display at a commerce environment;
obtain product information relevant to the product from one or more data sources, the product information obtained using the identification of the product;
determine real-time product information from the product information using characteristics of the physical display and the commerce environment; and
display, in a user interface operable in the commerce environment, the real-time product information.

18. The computer-readable storage medium of claim 17, wherein the computer-readable instructions further cause the computer to:
process input received in the user interface, including obtaining additional product information from the one or more data sources responsive to input received in the user interface.

19. The computer-readable storage medium of claim 17, wherein the computer-readable instructions further cause the computer to:
display, in the user interface, related product information obtained from the one or more data sources for one or more products related to the product.

20. The computer-readable storage medium of claim 17, wherein the one or more data sources include a product information database provided by an operator of the commerce environment or an entity associated with the operator of the commerce environment.

21. The computer-readable storage medium of claim 17, wherein the one or more data sources include one or more searchable websites.

22. The computer-readable storage medium of claim 17, wherein the one or more data sources include one or more social networks associated with a user or one or more social media sites associated with a user.

23. A system, comprising:
a product information database providing information for a plurality of products; and
a mobile wireless device connected to the product information database via a wireless network, and providing a referral application which when executed by the mobile wireless device performs the acts of:
obtaining an identification of a product provided in a physical display in a commerce environment;
obtaining product information relevant to the product from the product information database using the identification;
determining real-time product information based on the product information relevant to the product and the physical display of the product in the commerce environment; and
displaying, in a user interface on the mobile wireless device, the real-time product information.

24. The system of claim 23, wherein the referral application when executed by the mobile wireless device further performs the act of:
aggregating the product information relevant to the product obtained from the product information database with product information obtained from one or more additional data sources.

25. The system of claim 23, wherein the mobile wireless device includes a touchscreen, and wherein the user interface is provided through electronic display on the touchscreen.

26. The system of claim 23, wherein the referral application when executed by the mobile wireless device further performs the acts of:
providing, for display in the user interface on the mobile wireless device, related additional product information including information for one or more additional products related to the product.
